(19) United States
(12) Patent Application Publication
(10) Pub. No.: US 2023/0035712 A1
(43) Pub. Date: Feb. 2, 2023

(54) METHOD AND SYSTEM FOR SOCIAL COMMERCE AND GROUP DEAL PURCHASING

(71) Applicants: Inna Vedavyasa Sudhir Sharma, Ashburn, VA (US); Chandra Shekar Gowda, Ashburn, VA (US); Vishal Nangani, Euless, TX (US)

(72) Inventors: Inna Vedavyasa Sudhir Sharma, Ashburn, VA (US); Chandra Shekar Gowda, Ashburn, VA (US); Vishal Nangani, Euless, TX (US)

(21) Appl. No.: 17/876,411

(22) Filed: Jul. 28, 2022

Related U.S. Application Data
(60) Provisional application No. 63/226,219, filed on Jul. 28, 2021.

(51) Int. Cl. G06Q 30/06

(52) U.S. Cl. CPC G06Q 30/0635; G06Q 30/0641

(57) ABSTRACT

A computer-implemented method comprising, receiving, by one or more processors, a request to create a listing for a purchase of a product or service, wherein a quantity of greater than two of the product or service is required, analyzing, by one or more processors, a set of requirements to purchase the product or service based on a set of seller's requirements, applying, by one or more processors, the set of seller requirements to the listing, wherein the listing is depicted within a user interface, determining, by one or more processors, if a length of time restrictions has expired or a predetermined number of purchasers have joined the listing to purchase the product or service, wherein a user interface is manipulated based on the determination, and processing, by one or more processors, the listing based on the determination.

### CROSS-REFERENCE TO RELATED APPLICATIONS

This application is a continuation-in-part (and claims the benefit of priority under 35 USC 120) of U.S. application No. 63/226,219 filed Jul. 28, 2021. The disclosure of the prior applications is considered part of (and is incorporated by reference in) the disclosure of this application.

### BACKGROUND

This disclosure relates generally to a program to allow for groups of people to join together to purchase a bulk quantity of products or services , and more specifically to a method, computer program and computer system for enabling end to end process for buyers to create, join, invite others to a buying group to qualify and purchase products and services at discounted prices. It also includes gamification feature where each of the buyer can share the group deal with friends and followers in any social media platform and get rewarded for each purchase by them. The friends and followers are also rewarded when they join a group deal through the link shared with them.

Currently users use software to discover, buy products and/or services at discounted prices. Users also use software to discover new products and/or services. Users use social media software for social interaction around deals for the products and/or services. Users use eCommerce and other software to complete purchase of the service/products. Most of the users do not get rewarded for the products and/or services they share with their friends and followers when they purchase the products and/or services through the link. The friends and followers are also not rewarded when they join a group deal or make purchases through the link shared.

The present invention group deal process provides a significant improvement in user experience where on one software, the Users are able to combine social media-based interactions with ability to form a group to increase their purchase power and get deals for products and/or services that they can discover. The users and their friends and followers are also rewarded for each purchase made by their friends and followers using the product and/or service link shared by the user

### SUMMARY

In a first embodiment, the present invention is a computer-implemented method comprising: receiving, by one or more processors, a request to create a listing for a purchase of a product or service, wherein a quantity of greater than two of the product or service is required; analyzing, by one or more processors, a set of requirements to purchase the product or service based on a set of seller's requirements; applying, by one or more processors, the set of seller requirements to the listing, wherein the listing is depicted within a user interface; determining, by one or more processors, if a length of time restrictions has expired or a predetermined number of purchasers have joined the listing to purchase the product or service, wherein a user interface is manipulated based on the determination; and processing, by one or more processors, the listing based on the determination.

In a second embodiment, the present invention is a computer program product for gathering buyers for a bulk purchase, the computer program product comprising: a non-transitory computer readable storage medium having program instructions embodied therewith, the program instructions executable by a computing device to cause the computing device to: program instructions to receive a request to create a listing for a purchase of a product or service, wherein a quantity of greater than two of the product or service is required; program instructions to analyze a set of requirements to purchase the product or service based on a set of seller's requirements; program instructions to apply the set of seller requirements to the listing, wherein the listing is depicted within a user interface; program instructions to determine if a length of time restrictions has expired or a predetermined number of purchasers have joined the listing to purchase the product or service, wherein a user interface is manipulated based on the determination; and program instructions to process the listing based on the determination.

In a third embodiment, the present invention is a system comprising: a CPU, a computer readable memory and a non-transitory computer readable storage medium associated with a computing device; program instructions to identify bulk purchase opportunities available through sellers; program instructions to analyze a set of requirements for the bulk purchase opportunities based on a set of seller's requirements; program instructions to apply the set of seller requirements to a listing, wherein the listing is depicted within a user interface and a delivery location is set; program instructions to receive a request from at least two buyers, wherein the buyers are within a predetermined distance of the delivery location; program instructions to determine if a length of time restrictions has expired or a predetermined number of buyers have requested to join the listing, wherein a user interface is manipulated based on the determination; and program instructions to process the listing based on the determination, and provide the buyers with a notification of the determination.

### BRIEF DESCRIPTION OF THE DRAWINGS

Referring now to the drawings in which like reference numbers represent corresponding parts throughout:

FIG. 1 depicts a cloud computing node according to an embodiment of the present invention.

FIG. 2 depicts a cloud computing environment according to an embodiment of the present invention.

FIG. 3 depicts a block diagram depicting a computing environment according to an embodiment of the present invention.

FIG. 4 depicts a flowchart of the operational steps taken by a program to create a listing, within the computing environment of FIG. 1 according to an embodiment of the present invention

FIG. 5 depicts a flowchart of the operational steps taken by a program to accept a user to the list within the computing environment of FIG. 1 according to an embodiment of the present invention

FIG. 6 depicts a user interface, according to an embodiment of the present invention.

FIG. 7 depicts a user interface, according to an embodiment of the present invention.

FIG. 8 depicts a user interface, according to an embodiment of the present invention.

FIG. 9 depicts a user interface, according to an embodiment of the present invention.

### DETAILED DESCRIPTION

The present invention provides for an experience for merchants to plan, design, execute campaign for group deals or bulk purchases for their products or services (hereinafter “products”, “services”, “products/services”, “products and services”, “product or service”, and the like). The group deals become active when a group of minimum number of buyers is formed to purchase the product and/or service offered by the Merchants through the group deal. Group deal experience also provides machine learning model, Artificial Intelligence based inputs to Merchants to plan and design effective campaign parameters including but not limited to target product and/or service, pricing strategy, duration, minimum group size, target segmentation.

The present invention provides for a process for buyers to socially interact, get together as a group and determine a deal for products or services that is available for a group of minimum size formed within a specific time. The experience includes discovery of new deals relevant to the buyers, based on various factors and machine learning models and Artificial Intelligence recommendations. The users can form a new group or join existing group for the group deal. The users have a set time determined by the Merchant to form the group with minimum number of members to be eligible for the deal. The users can invite their contacts, friends, and family to join the group through the software or through other 3rd party existing software. The invitees can review the deal and decide to opt out or join the group. When an invitee joins the group and gets the deal, both the user that invited and the invitee get rewarded with reward points that they can use for future purchases in the platform. The members of the group can interact with each other and the merchant on the software. If the minimum number of members needed for the group within the specified time is met, the deal gets executed and the group members get the deal. If the criteria are not met, the group members get an option to join any other existing group and get the money back for the payment if any.

The present invention provides a user experience to allow end to end processing to discover, select, discuss, purchase, and settlement the purchase of product or services for a recipient, or for the group members based on the group's purpose. It also provides an opportunity for each user to share the group deal details with friends, family and followers in any social media platform and get rewarded for each purchase done through the link shared for the group deal.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

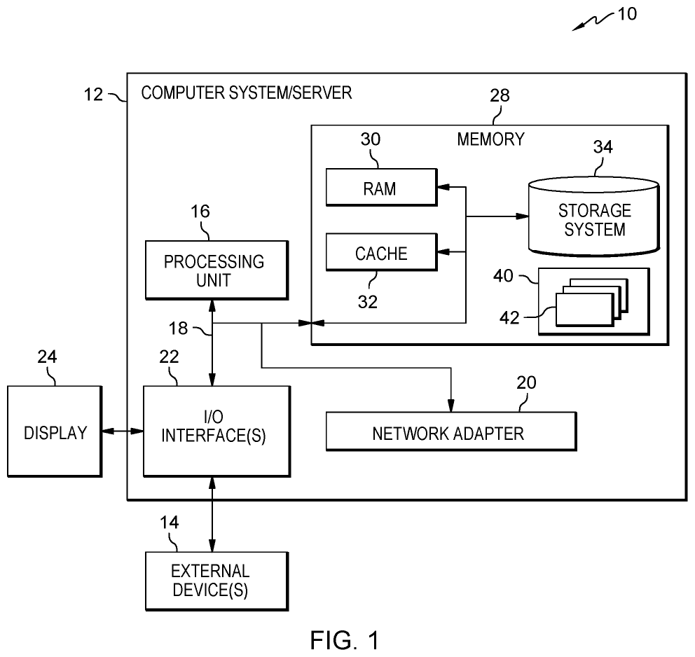

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

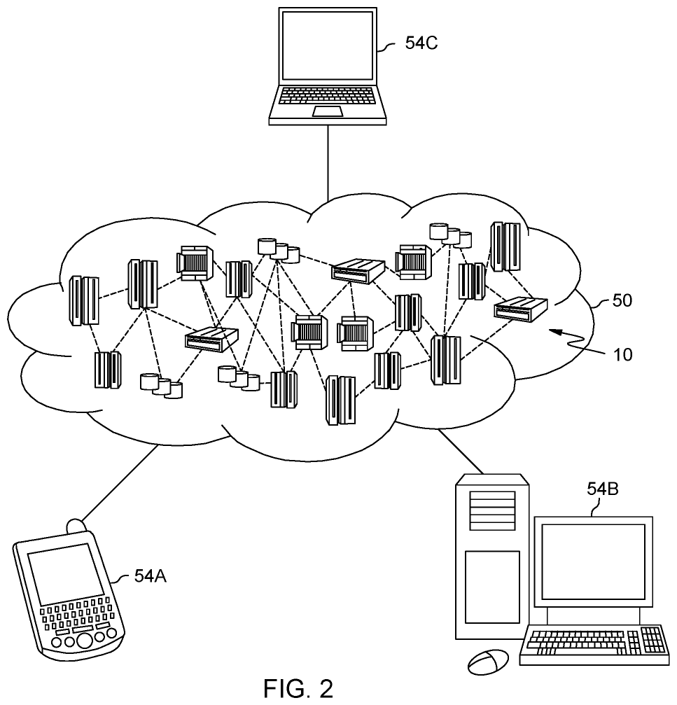

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, and laptop computer 54C may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

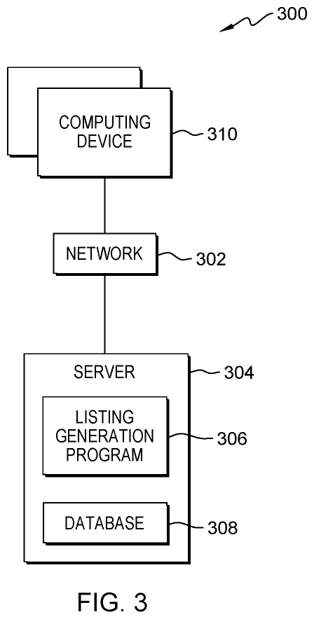

Referring back to FIG. 1, the Program/utility 40 may include one or more program modules 42 that generally carry out the functions and/or methodologies of embodiments of the invention as described herein. Specifically, the program modules 42 handles the group purchasing process by both providing the user interface and system which the users are able to create the listings, but also process the listing and confirm the requirements are met to complete the transaction Other functionalities of the program modules 42 are described further herein such that the program modules 42 are not limited to the functions described above. Moreover, it is noted that some of the modules 42 can be implemented within the infrastructure shown in FIGS. 1 and 2. For example, the modules 42 may be representative of a listing generation program as shown in FIG. 3.

FIG. 3 depicts a block diagram of a computing environment 300 in accordance with one embodiment of the present invention. FIG. 1 provides an illustration of one embodiment and does not imply any limitations regarding the environment in which different embodiments maybe implemented.

In the depicted embodiment, computing environment 300 includes network 302, computing devices 310, server 304, listing generation program 306, and database 308. Computing environment 300 may include additional servers, computers, or other devices not shown.

Network 302 may be a local area network (LAN), a wide area network (WAN) such as the Internet, any combination thereof, or any combination of connections and protocols that can support communications between, computing device 310, and server 304 in accordance with embodiments of the invention. Network 302 may include wired, wireless, or fiber optic connections.

Server 304 may be a management server, a web server, or any other electronic device or computing system capable of processing program instructions and receiving and sending data. In other embodiments server 304 may be a laptop computer, tablet computer, netbook computer, personal computer (PC), a desktop computer, or any programmable electronic device capable of communicating via network 302. In one embodiment, server 304 may be a server computing system utilizing multiple computers as a server system, such as in a cloud computing environment. In one embodiment, server 304 represents a computing system utilizing clustered computers and components to act as a single pool of seamless resources. In the depicted embodiment database 308 is located on server 304. server 304 may include components, as depicted and described in further detail with respect to FIG. 3.

Listing generation program 306 operates create the listings, monitor the listings, provide the interface for the users to interact with one another and the program, allow the user's to manually create the listings, to process the listings, and the purchasing of the product and/or service. In the depicted embodiment, listing generation program 306 utilizes network 302 to access the computing device 310, and communicates with database 308. In one embodiment, listing generation program 306 resides on server 304. In other embodiments, listing generation program 306 may be located on another server or computing device, provided listing generation program 306 has access to database 308. The listing generation program 306 is responsible for the group deal experience, the purpose is to provide a discounted price for a product or service through the purchase of the product or service in bulk.

Database 308 may be a repository that may be written to and/or read by listing generation program 306. In one embodiment, database 308 is a database management system (DBMS) used to allow the definition, creation, querying, update, and administration of a database(s). In the depicted embodiment, database 308 resides on server 304. In other embodiments, database 308 resides on another server, or another computing device, provided that database 308 is accessible to listing generation program 306.

Computing device 310 may be a management server, a web server, or any other electronic device or computing system capable of processing program instructions and receiving and sending data. In other embodiments, computing device 310 may be a laptop computer, tablet computer, netbook computer, personal computer (PC), a desktop computer, or any programmable electronic device capable of communicating with server 304 via network 302. In other embodiments, computing device 310 may be a server computing system utilizing multiple computers as a server system, such as in a cloud computing environment. In one embodiment, computing device 310 represents a computing system utilizing clustered computers and components to act as a single pool of seamless resources. computing device 310 may include components, as depicted and described in further detail with respect to FIG. 1. In the depicted embodiment, the computing device 310 is a plurality of different computing devices used by a plurality of users all accessing the listing generation program 306.

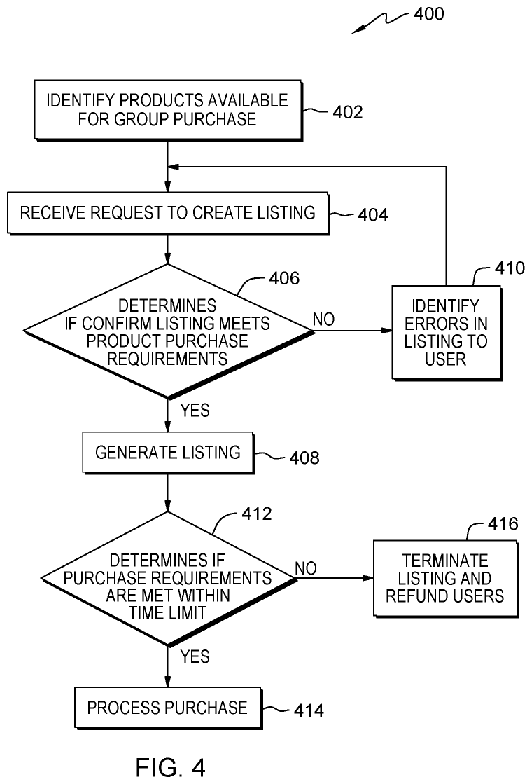

FIG. 4 shows flowchart 400 depicting a method according to the present invention. The method(s) and associated process(es) are now discussed, over the course of the following paragraphs, with extensive reference to FIG. 2, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 402, listing generation program 306 identifies products which are available for group purchase. In many instances, there is an opportunity to buy one or a few units of a product and/or service at a higher cost and the opportunity to buy a few to many units of the product and/or service at a lower cost or price. The opportunity to purchase the products and/or services in bulk is cost effective for both the buyer and the seller. The seller has few shipping requirements, and the buyer receives a cheaper price. In the present invention, the listing generation program 306 is able to identify products or services which can be purchased in bulk quantity (e.g., a quantity greater than two). This can be done through a search of various sellers (direct sellers and third parties) and retailers via a function of the present program, by a third-party program or system, or accessing various sellers based on set requirements generated by the listing generation program 306. In some embodiments, the users may present the product (or a link to the product and/or service) to the listing generation program 306 when creating the listing, and the listing generation program 306 confirms the authenticity of the product and the bulk buying option. The verification of the product is performed via the listing generation program 306 reviewing the information provided by the user. In some embodiments, the listing generation program 306 is able to compare sales of products to determine which of the sales are more cost effective and have a greater time till expiration to provide the greatest benefit to the buyers.

In step 404, listing generation program 306 receives a request to generate a listing for a product and/or a service . This request may be automatically generated by the listing generation program 306 or may be created by a user. In the embodiment where the listing generation program 306 generates the listing, based on the listing generation program 306 analysis and/or review of a product or service that provides for a bulk purchase or group purchase discount, the listing generation program 306 processes the requirements which each user must meet to partake in the purchase. These may include a lead user at which the shipment is delivered to and allowing users within a certain distance of the lead user to be from said lead user, the number of people needed or the quantity of the product or service which needs to be purchased (if a single user wanted more than one of the product and/or service) and expiration date of the opportunity to purchase. In the embodiment, where a user creates the listing, they set forth the restrictions on the purchase, similar to that of the listing generation program 306 generated restrictions. These can be but are not limited to quantity of the product and/or service , minimum group size (e.g., the number of individual purchasers) or number of purchasers required, deadline for sale, distance from deliver site, etc. This is advantageous to be able to select a minimum number of individuals, to increase the likelihood that the requirements will be met, and the purchasers are more likely to fulfil their obligation of the purchase, where if only one buyer is purchasing the bulk quantity of products and/or services, they are more likely to fail to complete the purchase.

The user may also set the rewards in reward points for purchase. The reward points may be used within the program to purchase additional products and/or services or used for other perks.

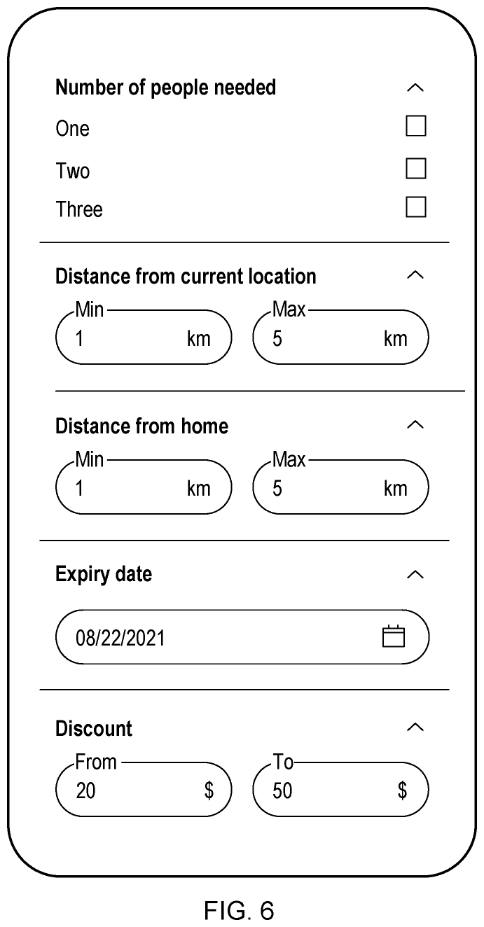

As shown in FIG. 6, a user interface 600 is shown, where a set of restrictions/criteria are shown for the user to adjust when creating the listing. In the depicted embodiments, the restrictions are the minimum quantity of people (or purchases) required 601, the distance of the users from the lead user's location 602, the distance the users are from their home location 603, the expiration date of the deal 604, and the discount from the products original price 605. In additional setups, various products and services may have other specific restrictions which the user or listing generation program 306 may have to incorporate. In additional embodiments, FIG. 6 could also be shown in a user's search for a product or listing and restrictions which the user wants to incorporate when searching for deals.

In decision 406, listing generation program 306 determines if the listing meets the product and/or service purchase requirements. In embodiments, where the listing generation program 306 generates the listing, the listing complies with the purchase given that the listing generation program 306 reviews the requirements prior to creating the listing and determines if based on the possible restrictions if the listing can be created. In embodiments where the user creates the listing, the listing generation program 306 reviewing both the listing restrictions and the product purchase requirements. If it determined that the listing restrictions meet the purchase requirements, the listing is created for public access. If the listing restrictions and the purchase requirements are not correct, the errors are identified for the user to correct or adjust. Examples of errors which may occur, but not limited to, are deadlines for the purchase beyond the seller's deadlines, quantities which do not qualify for the bulk discount, shipping location outside of seller's range, unspecified delivery date or pickup deadline, incorrect shipping parameters (e.g., shipping to each buyer individually). Based on the product, the seller, and user a variety of issues could be present which the listing generation program 306 may identify.

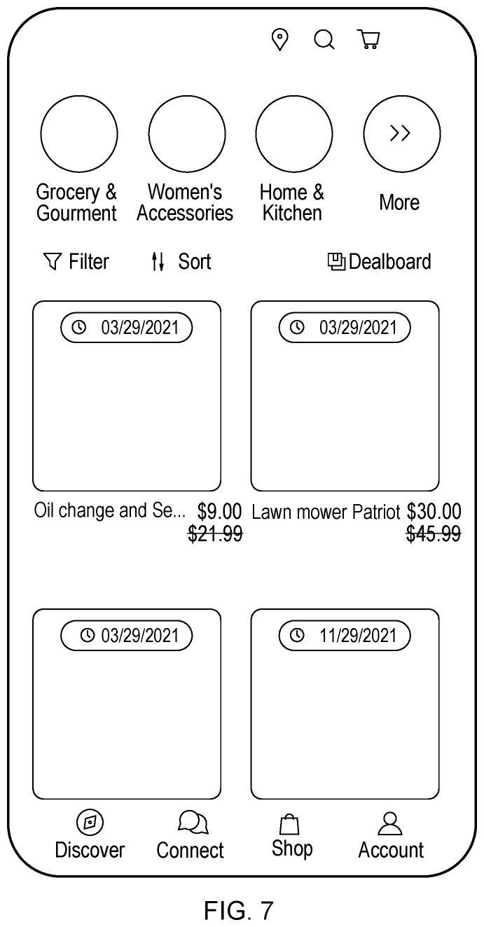

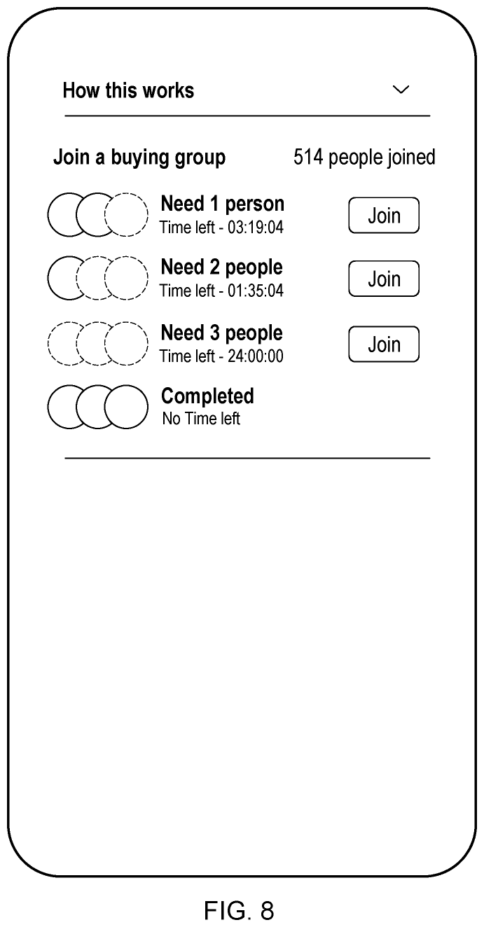

In step 408, listing generation program 306 generates the listing to be presented to the public. As shown in FIG. 7, a user interface 700 is shown having categories 701 which the user can use to narrow their search, and a set of listings 704 which showcase the deadline 703, the price (and discount) 705 and a set of icons for the user to interact with. In some embodiments, the listing generation program 306 assigns at least one category to each listing associated with a known or created category. In some embodiments, the deadline is modified or adjusted based on the time to the deadline to show user's that the deal has almost or is about to expire and may sort the listings by the deadline. A user can use the search icon to access the user interface 600. Based on the user's filters and sorting, they may see the present listing or other listings. The filters may also be based on the user profile and user specific data (e.g., location). In additional embodiments, there are points which are also available to be collected or rewarded after taking part in a sale which can be used for other sales or purchases. Once a user selects a deal, they are shown the user interface 800, shown in FIG. 8. Each deal may have multiple chooses (groups) based on the location of the lead user and the location of the user searching for the deal and the restrictions applied. Groups 801 are shown that meet the restrictions of the lead user, and the user profile settings. In some embodiments, the lead user must be a predetermined distance from a lead user of an already created group. This is to allow a greater poll of users to access each offer. If the user attempting to create the listing is within a predetermined distance of an already created group. The listing generation program 306 directs the user to the already formed group. In instances where a deadline 703 is shown, the earliest deadline of the groups is shown to the user on the user interface 700. In some embodiments, when a group expires, the users are added to another group that is still active and within the user's restrictions or limits. In some embodiments, based on the user's restrictions and the groups are combined to achieve the desired quantity of purchasers for the sale. For example, if the user set's their radius to 10 miles, all groups outside that 10-mile radius are removed (or hidden) from the user. The depicted embodiment shows, a set of groups under the listings indicating the remaining number of people (or purchases) which are required to meet the group requirements, and the time remaining. This can be shown based on the user filter and user interface setup.

In step 410, listing generation program 306 identifies errors in the listing for which the user would need to adjust or correct before a listing can be published to the public. The listing generation program 306 may highlight or provide other visual indicators to the user of which aspects of the listing have errors or need to be corrected or need to be added. The listing generation program 306 provides the user with an explanation to the errors or may request additional information. This may be due to the product or service requirements or the listing being incomplete.

In decision 412, listing generation program 306 determines if the purchase requirements have been met. Based on the listing time restrictions, and purchase quantity restrictions, if the restrictions are not met by the time limit or within a predetermined time from the creation of the listing, the purchase is terminated, and the listing is removed. If the listing requirements are met at or before the time limit, the purchase is processed. In some embodiments users who were in the listing are moved to another listing that is active for the same product and within the same restrictions

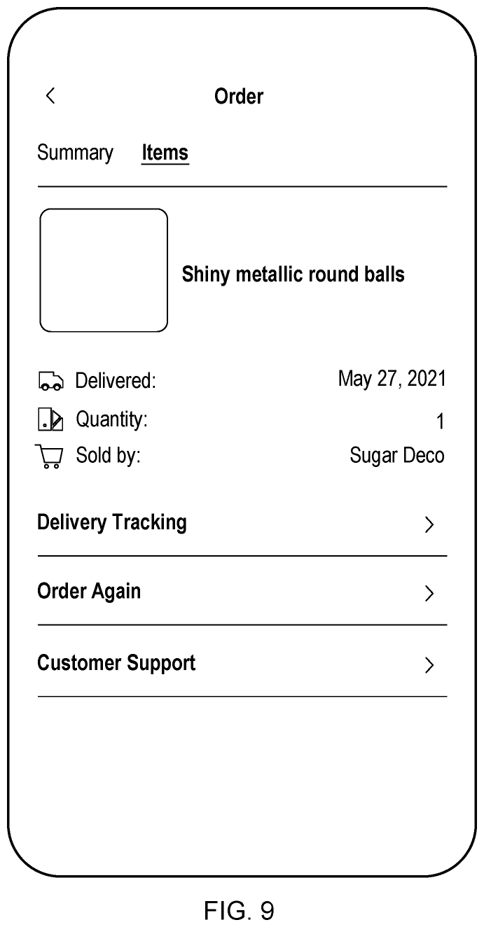

In step 414, listing generation program 306 process the purchase of the product and/or service. In one embodiment, the listing generation program 306 handles the process of the payment from all the users who agreed to the purchase to process the entire transaction at once, provides the receipt to the users of the sale and also the shipping information or access information to sale, as shown user interface 900 in FIG. 9. The user then receives the shipping information, the pickup or drop off location and time, and the like. In some embodiments, the listing generation program 306 is able to provide direct shipping for each product to each user to avoid the bulk shipment to a single location. This can be done for security reasons or for ease of process for the user. In some embodiments, the voucher or code to access the service is provided to the user in the event where a service is purchased and not an actual product through a link or a code (e.g., a QR code). The listing generation program 306 also provides the rewards awarded to user for the purchase and also the rewards awarded to the user for purchases by other users through the listing link shared by the user.

In step 416, listing generation program 306 terminates the listing and refunds the users where money was transferred to either the seller or an account which holds the money while the sale is pending. In some embodiments, the funds are withdrawn from the user after accepting the purchase, and in other embodiments the funds are withdrawn from the user once the purchase has been completed.

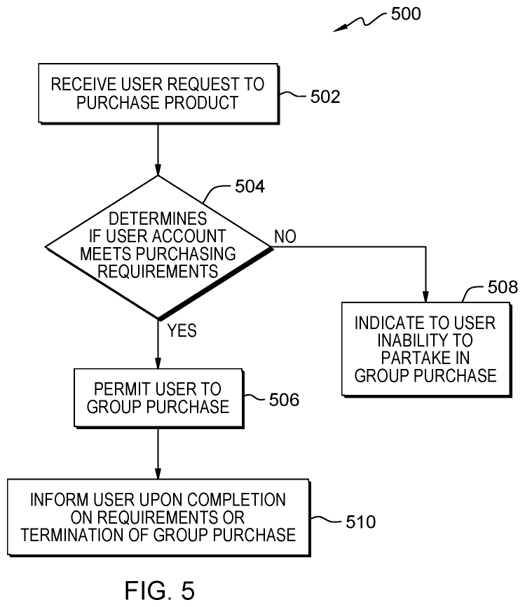

FIG. 5 shows flowchart 500 depicting a method according to the present invention. The method(s) and associated process(es) are now discussed, over the course of the following paragraphs, with extensive reference to FIG. 2, in accordance with one embodiment of the present invention.

The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 502, listing generation program 306 receives a user's request to take part in the purchase of the product or service through the user interface.

In decision 504, listing generation program 306 determines if the user meets the requirements to participate in the purchase of product or service. This may be related to time of expiration of the offer, the location of the user, or other variables or factors which the listing generation program 306 identifies are part of the offer. A user's history may be a factor which is taken into account based on previous successful purchases, age of the user's account, or reviews of the user profile.

In step 506, listing generation program 306 permits the user to offer and allows them to be an active buyer of the product or service. This will connect the user with the other active users to communicate regarding the product and/or service, invite other users to join in the offer, or the like. The listing generation program 306 also provides feature for the user to share the listing with a unique code, with other users within the program or outside programs.

In step 508, listing generation program 306 indicates to the user their inability to participate in the offer. This may include providing a reason as to the cause of the user's inability to participate.

In step 510, listing generation program 306 informs the user's at either the conclusion of the offer based on failure to meet all the requirements, or upon the completion of the requirements for the purchase of the product and/or service. As shown in FIG. 9, the successful ordering of a product and/or service provides the user with a confirmation of the order, delivery date, deliver tracking, and the like related to the offer. The listing generation program 306 also provides the rewards awarded to user for the purchase and also the rewards awarded to the user for purchases by other users through the listing link shared by the user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention. In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g., attached, adhered, joined) are to be construed broadly and may include intermediate members between a connection of elements and relative movement between elements. As such, joinder references do not necessarily infer those two elements are directly connected and in fixed relation to each other. Moreover, network connection references are to be construed broadly and may include intermediate members or devices between network connections of elements. As such, network connection references do not necessarily infer those two elements are in direct communication with each other. In some instances, in methodologies directly or indirectly set forth herein, various steps and operations are described in one possible order of operation, but those skilled in the art will recognize that steps and operations may be rearranged, replaced or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalents.

What is claimed is:

1. A computer-implemented method comprising:
receiving, by one or more processors, a request to create a listing for a purchase of a product or service, wherein a quantity of greater than two of the product or service is required;
analyzing, by one or more processors, a set of requirements to purchase the product or service based on a set of seller's requirements;
applying, by one or more processors, the set of seller requirements to the listing, wherein the listing is depicted within a user interface;
determining, by one or more processors, if a length of time restrictions has expired or a predetermined number of purchasers have joined the listing to purchase the product or service, wherein a user interface is manipulated based on the determination; and
processing, by one or more processors, the listing based on the determination.

2. The computer-implemented method of claim 1, wherein a minimum number of purchasers greater than two is at least one of the buyer's requirements.

3. The computer-implemented method of claim 1, further comprising, establishing, by one or more processors a distance variable applied by the buyer's requirements and a distance value applied to a set of user's restrictions to determine which listings are presented to the user in the user interface.

4. The computer-implemented method of claim 1, further comprising, generating, by one or more processors, more than one version of the listing, wherein each buyer is a predetermined distance from one another.

5. The computer-implemented method of claim 1, further comprising, population, by one or more processors, the user interface with at least one listing, wherein a product original price and a product discount price are shown.

6. The computer-implemented method of claim 1, further comprising, providing, by one or more processors, a date imposed over the listing, wherein the date indicates a deadline for the listing and the date adjusts based on the proximity of the deadline.

7. The computer-implemented method of claim 1, further comprising, analyzing, by one or more processors, a set of buyer's requirements and comparing the set of seller's requirements, to confirm that the set of buyer's requirements are within the set of seller's requirements.

8. The computer-implemented method of claim 1, further comprising, sorting, by one or more processors, the groups based on a number of needed active participants.

9. A computer program product for gathering buyers for a bulk purchase, the computer program product comprising:
a non-transitory computer readable storage medium having program instructions embodied therewith, the program instructions executable by a computing device to cause the computing device to:
program instructions to receive a request to create a listing for a purchase of a product or service, wherein a quantity of greater than two of the product or service is required;
program instructions to analyze a set of requirements to purchase the product or service based on a set of seller's requirements;
program instructions to apply the set of seller requirements to the listing, wherein the listing is depicted within a user interface;
program instructions to determine if a length of time restrictions has expired or a predetermined number of purchasers have joined the listing to purchase the product or service, wherein a user interface is manipulated based on the determination; and
program instructions to process the listing based on the determination.

10. The computer program product of claim 9, wherein a minimum number of purchasers greater than two is at least one of the buyer's requirements.

11. The computer program product of claim 9, further comprising, program instruction to establish a distance variable applied by the buyer's requirements and a distance value applied to a set of user's restrictions to determine which listings are presented to the user in the user interface.

12. The computer program product of claim 9, further comprising, program instructions to generate more than one version of the listing, wherein each buyer is a predetermined distance from one another.

13. The computer program product of claim 9, further comprising, program instructions to populate the user interface with at least one listing, wherein a product original price and a product discount price are shown.

14. The computer program product of claim 9, further comprising, program instructions to sort the groups by the number of buyers required and the proximity to the time restriction.

15. The computer program product of claim 9, further comprising, program instructions to compare at least two of the same product listing for sale by at least two sellers and selecting the sale which provides the greater discount and time to expiration.

16. A system comprising:
a CPU, a computer readable memory and a non-transitory computer readable storage medium associated with a computing device;
program instructions to identify bulk purchase opportunities available through sellers;
program instructions to analyze a set of requirements for the bulk purchase opportunities based on a set of seller's requirements;
program instructions to apply the set of seller requirements to a listing, wherein the listing is depicted within a user interface and a delivery location is set;
program instructions to receive a request from at least two buyers, wherein the buyers are within a predetermined distance of the delivery location;
program instructions to determine if a length of time restrictions has expired or a predetermined number of buyers have requested to join the listing, wherein a user interface is manipulated based on the determination; and
program instructions to process the listing based on the determination and provide the buyers with a notification of the determination.

17. The system of claim 16, further comprising, program instructions to manipulate the user interface as the length of time restrictions comes to a close.

18. The system of claim 16, further comprising, program instructions to combine more than one listing, wherein each of the listings does not have a predetermined number of buyers but combined they do have at least the predetermined number of buyers.

19. The system of claim 16, further comprising, program instructions to sort the listing on the user interface based on the proximity of the time left based on the time restriction.

20. The system of claim 16, further comprising, program instructions to sort a group of listings by the number of buyers.
